(19) United States
(12) Patent Application Publication
(10) Pub. No.: US 2013/0155258 A1
(43) Pub. Date: Jun. 20, 2013

(54) DETERMINATION CIRCUIT

(71) Applicants: Atsushi Wada, Gifu-ken (JP); Hajime Mizukami, Gifu-ken (JP)

(72) Inventors: Atsushi Wada, Gifu-ken (JP); Hajime Mizukami, Gifu-ken (JP)

(21) Appl. No.: 13/687,018

(22) Filed: Nov. 28, 2012

(30) Foreign Application Priority Data
Dec. 2, 2011 (JP) 2011-264756

(51) Int. Cl. H04N 17/00

(52) U.S. Cl. CPC H04N 17/00
USPC 348/189

(57) ABSTRACT

A determination circuit includes a terminal configured to be connected to one end of a cable having an other end connected to a display device so that an image corresponding to an inputted video signal is displayed on the display device, a voltage detection unit configured to detect a terminal voltage at the terminal, and a determination unit configured to determine whether the cable is disconnected or not between the terminal and the display device based on a predetermined value corresponding to a minimum level of a synchronizing signal contained in the video signal to be generated at the terminal and a minimum value of the terminal voltage detected when the synchronizing signal is inputted to the terminal, after the cable is connected between the terminal and the display device.

### CROSS-REFERENCE TO RELATED APPLICATION

This application claims the benefit of priority to Japanese Patent Application No. 2011-264756, filed Dec. 2, 2011, of which full contents are incorporated herein by reference.

### BACKGROUND OF THE INVENTION

1. Field of the Invention

The present invention relates to a determination circuit.

2. Description of the Related Art

Many mobile devices currently in widespread use are connected to various devices such as a personal computer and a monitor, in some cases (see Japanese Laid-Open Patent Publication No. 2010-205437, for example). Thus, in general, the mobile devices each are provided with a common port connectable to the various devices. The common port includes a port connected with a Micro-USB (Universal Serial Bus) plug, for example.

The Micro-USB plug, for example, is not provided with a terminal dedicated to transmission/reception of a video signal. Thus, it is required to use an identification terminal, for example, among terminals of the Micro-USB plug, in order to cause a monitor to receive the video signal outputted from a CPU (Central Processing Unit) of a mobile device and the like. As such, the identification terminal is used as a terminal to which the video signal is outputted, thereby being able to display an image corresponding to the video signal on the monitor. However, after a cable is disconnected between the mobile device and the monitor, another device might be connected to the mobile device. Thus, the CPU of the mobile device or the like is required to reliably detect that the cable is disconnected between the mobile device and the monitor. In usual cases, the identification terminal has a disconnection detection function in addition to an identification detection function when the cable is inserted, but unlike the usual cases, a method of reliably detecting disconnection of the identification terminal in a state where a video signal is outputted is separately needed.

### SUMMARY OF THE INVENTION

A determination circuit according to an aspect of the present invention, includes: a terminal configured to be connected to one end of a cable having an other end connected to a display device, so that an image corresponding to an inputted video signal is displayed on the display device; a voltage detection unit configured to detect a terminal voltage at the terminal; a determination unit configured to determine whether the cable is disconnected or not between the terminal and the display device, based on a predetermined value corresponding to a minimum level of a synchronizing signal contained in the video signal to be generated at the terminal and a minimum value of the terminal voltage detected when the synchronizing signal is inputted to the terminal, after the cable is connected between the terminal and the display device.

### BRIEF DESCRIPTION OF THE DRAWINGS

For more thorough understanding of the present invention and advantages thereof, the following description should be read in conjunction with the accompanying drawings, in which:

FIG. 1 is a schematic diagram illustrating a mobile device 10 according to an embodiment of the present invention and a device to be connected to the mobile device 10;

FIG. 2 is a diagram illustrating an example of a configuration of plugs 21 and 23;

FIG. 3 is a diagram illustrating an example of a configuration of a switch IC 30;

FIG. 4 is a diagram illustrating an example of a configuration of an identification voltage detection circuit 54;

FIG. 5 is a diagram for describing a voltage Vid when a cable 16 is connected between a mobile device 10 and a monitor 18 are connected to each other;

FIG. 6 is a diagram for describing a voltage Vid when a plug 23 on a mobile device 10 side of a cable 16 is removed;

FIG. 7 is a diagram for explaining a voltage Vid when a plug 24 on a monitor 18 side of a cable 16 is removed;

FIG. 8 is a diagram illustrating an outline of a vertical synchronizing signal in a video signal Vs;

FIG. 9 is a schematic diagram illustrating a horizontal synchronizing signal and an effective video signal in a video signal Vs;

FIG. 10 is a diagram illustrating an example of a waveform of the voltage Vid when a vertical synchronizing pulse is outputted;

FIG. 11 is a diagram illustrating an example of a waveform of a voltage Vid when a horizontal synchronizing pulse is outputted;

FIG. 12 is a diagram illustrating an example of a functional block realized by a CPU 31a;

FIG. 13 is a flowchart illustrating an example of processing executed by a CPU 31a;

FIG. 14 is a diagram illustrating an example of a configuration of a switch IC 36;

FIG. 15 is a diagram illustrating a relationship between a latch circuit 100 and an identification voltage detection circuit 54;

FIG. 16 is a diagram for describing a voltage V3;

FIG. 17 is a diagram illustrating an example of a functional block realized by a CPU 31b; and

FIG. 18 is a flowchart illustrating an example of a processing executed by a CPU 31b.

### DETAILED DESCRIPTION OF THE INVENTION

At least the following details will become apparent from descriptions of this specification and of the accompanying drawings.

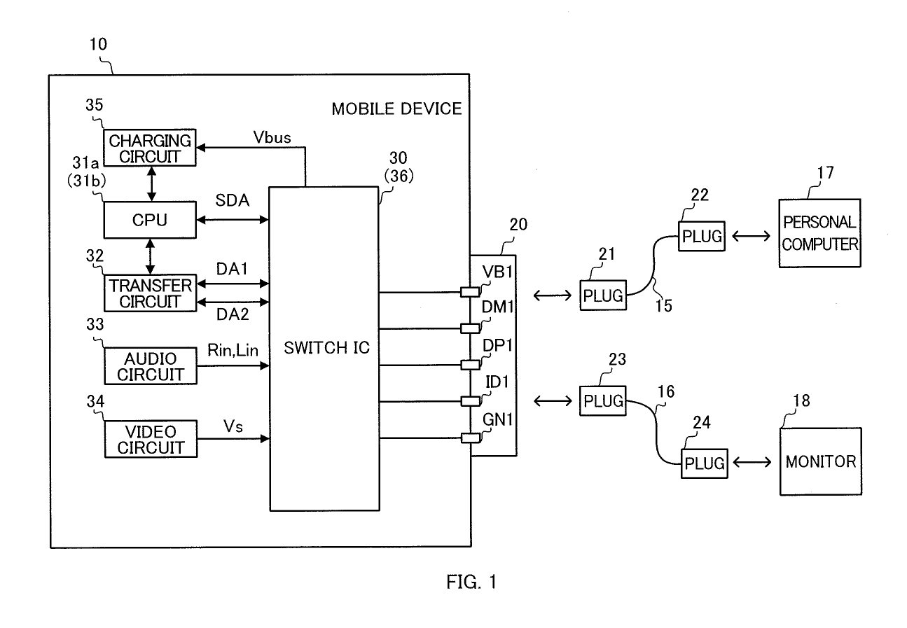

FIG. 1 is a schematic diagram illustrating a mobile device 10 according to an embodiment of the present invention and a device configured to be connected to the mobile device 10. The mobile device 10 is a smartphone, for example, and includes a port 20 connected with a plug for Micro-USB, for example.

A cable 15 is provided with a plug 21 for Micro-USB and a plug 22 for personal computer, and the cable 15 is used to connect the mobile device 10 and a personal computer 17 to each other.

A cable 16 is provided with a plug 23 for Micro-USB and a plug 24 for monitor. The cable 16 is used to connect the mobile device 10 and a monitor 18 to each other. When the mobile device 10 and the personal computer 17 are connected to each other, the plug 21 is inserted to the port 20, while when the mobile device 10 and the monitor 18 are connected to each other, the plug 23 is inserted to the port 20. Ports of the personal computer 17 and the monitor 18 whereto the plugs 22 and 24 compatible with the respective devices are inserted, respectively, are omitted for convenience.

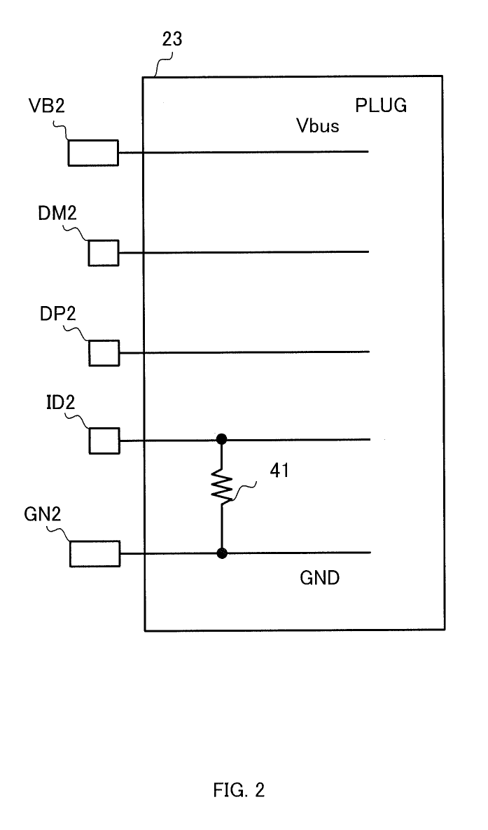

FIG. 2 is a schematic diagram illustrating the plug 23. The plug 23 is provided with terminals VB2, DM2, DP2, ID2, and GN2.

The terminals VB2 and GN2 are terminals corresponding to a power-supply terminal and a ground terminal, respectively, in a common plug for Micro-USB. When the plug 23 is connected to a device or the like, the terminal VB2 is applied with a predetermined power-supply voltage Vbus, and the terminal GN2 is applied with a ground voltage GND (0 V).

The terminals DM2 and DP2 each are a terminal corresponding to a terminal for data communication in a common Micro-USB plug. In general, a 15 kΩ pull-down resistor and a terminating resistor are connected to the terminals DM2 and DP2, but they are omitted for convenience, here.

The terminal ID2 is a terminal corresponding to an identification terminal in a common Micro-USB plug. A resistor having a resistance value (impedance) corresponding to the type of the device is connected to the terminal ID2 so that the device connected to the mobile device 10 can be identified on the mobile device 10 side. Specifically, a resistor 41 having a resistance value indicating that the device connected to the mobile device 10 is the monitor 18 is connected to the terminal ID2.

The plug 21 used for the cable 15 of the personal computer 17 has a terminal similar to that of the plug 23 in FIG. 2, though not particularly illustrated. However, the terminal ID2 of the plug 21 is not connected to a resistor but is in an open state.

The port 20 of the mobile device 10 in FIG. 1 is provided with terminals VB1, DM1, DP1, ID1, and GN1 whereto the terminals VB2, DM2, DP2, ID2, and GN2 of the plugs 21 and 23 illustrated in FIG. 2 is connected, respectively. The terminals VB2 and GN2 are formed to be longer than other terminals so that, when the plugs 21 and 23 are connected to the mobile device 10, the terminals VB2 and GN2 in the terminals of the plugs 21 and 23 are connected to the terminals on the mobile device 10 side prior to other terminals are connected thereto.

The mobile device 10 includes a switch IC (Integrated Circuit) 30, a CPU (Central Processing Unit) 31a, a transfer circuit 32, an audio circuit 33, a video circuit 34, and a charging circuit 35.

The switch IC 30 is a circuit configured to exchange various signals and data between the terminals of the port 20 and the circuits such as the CPU 31a, the video circuit 34 and the like. The switch IC 30 detects a voltage at the terminal ID1 when the terminal of the plugs 21 and 23 is connected to the terminal on the mobile device 10 side, and determines the type of the device connected to the mobile device 10. The switch IC 30 outputs, as data SDA, a determination result indicating the type of the device and a detection result of the voltage at the terminal ID1, to the CPU 31a.

The CPU 31a integrally controls the blocks of the mobile device 10 based on an output from the switch IC 30, an instruction from a user and the like. Then, the CPU 31a outputs, as the data SDA, a command to instruct an operation of the switch IC 30 and the like to the switch IC 30, based on the determination result from the switch IC 30 and the like. Further, the CPU 31a determines whether the cable 16 is disconnected or not, after the monitor 18 is connected to the mobile device 10 through the cable 16. Details of the CPU 31a will be described later.

The transfer circuit 32 exchanges data DA1 and DA2 between the terminals DM1, DP1 and the CPU 31a based on the instruction of the CPU 31a, if the device connected to the mobile device 10 is a data communication device such as the personal computer 17 or the like.

The audio circuit 33 outputs audio signals Rin and Lin based on the instruction of the CPU 31a, if the device connected to the mobile device 10 is a display device such as the monitor 18 or the like.

The video circuit 34 outputs the video signal Vs based on the instruction of the CPU 31a, if the device connected to the mobile device 10 is a display device such as the monitor 18 or the like.

The charging circuit 35 charges a battery (not shown) of the mobile device 10 based on the instruction of the CPU 31a, if the device connected to the mobile device 10 is a charger (not shown).

The switch IC 30 and the CPU 31a are equivalent to the determination circuit.

### ==Details of Switch IC 30 (First Embodiment of the Present Invention)==

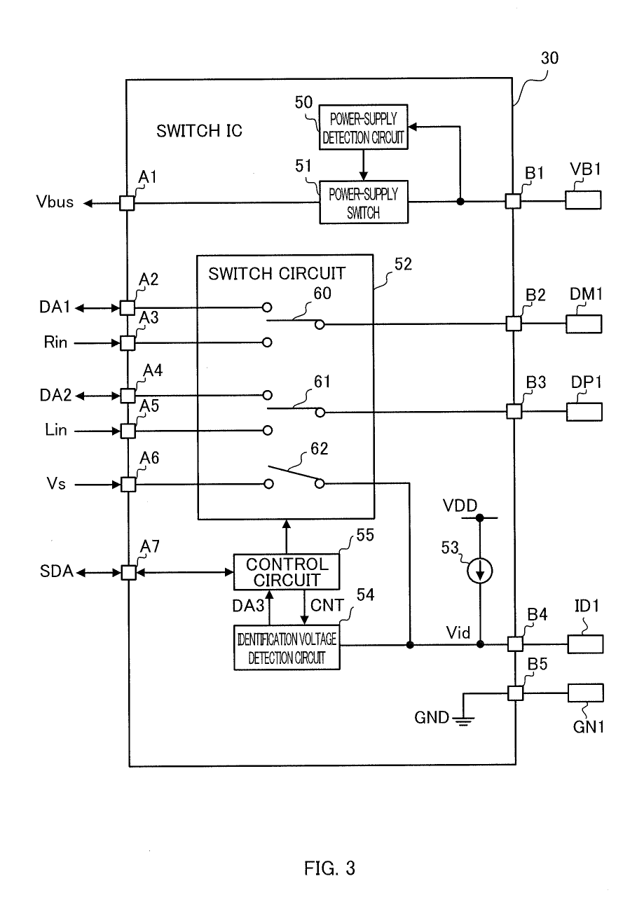

FIG. 3 is a diagram illustrating the details of the switch IC 30. The switch IC 30 includes a power-supply detection circuit 50, a power-supply switch 51, a switch circuit 52, a current source 53, an identification voltage detection circuit 54, a control circuit 55, and terminals A1 to A7 and B1 to B5.

The power-supply detection circuit 50 detects whether or not the power-supply voltage Vbus at the terminal VB2 is applied to the terminal VB1, based on the voltage at the terminal VB1, that is, whether or not the terminal VB1 and the terminal VB2 are connected to each other.

The power-supply switch 51 is ON when the terminal VB1 and the terminal VB2 are connected to each other, that is, when the voltage at the terminal VB1 reaches a voltage equal to or greater than a predetermined voltage in accordance with the power-supply voltage Vbus at the terminal VB2. Then, the power-supply switch 51 outputs the power-supply voltage Vbus to various circuits (not shown) provided in the charging circuit 35 and the mobile device 10 through the terminal A1. The power-supply switch 51 is OFF when the terminal VB1 and the terminal VB2 are not connected to each other (or if reaches a voltage equal to or lower than the predetermined voltage).

The switch circuit 52 includes switches 60 to 62 performs switching in accordance with the instruction from the control circuit 55.

The switch 60 connects between either one of a terminal A2, through which the data DA1 is inputted or outputted, and a terminal A3, through which the audio signal Rin from the audio circuit 33 is inputted, and a terminal B2 connected to the terminal DM1. The data DA1 is data to be exchanged between the terminal A2 and the transfer circuit 32. Thus, if the terminal A2 and the terminal B2 are connected to each other, for example, the data DA1 is exchanged between the transfer circuit 32 and the terminal DM1. Whereas, if the terminal A3 and the terminal B2 are connected to each other, the audio signal Rin is outputted to the terminal DM1.

The switch 61 connects between either one of a terminal A4, through which the data DA2 is inputted or outputted, and a terminal A5, through which the audio signal Lin from the audio circuit 33 is inputted, and a terminal B3 connected to the terminal DP1. The data DA2 is data to be exchanged between the terminal A4 and the transfer circuit 32. Thus, if the terminal A4 and the terminal B3 are connected to each other, the data DA2 is exchanged between the transfer circuit 32 and the terminal DP1. Whereas, if the terminal A5 and the terminal B3 are connected to each other, the audio signal Lin is outputted to the terminal DP1.

The switch 62 is provided between a terminal A6, through which the video signal Vs is inputted, and a terminal B4 connected to the terminal ID1. Thus, if the switch 62 is turned on, the video signal Vs is outputted to the terminal ID1.

The current source 53 supplies a predetermined current Ib to the terminal ID1 so that a voltage corresponding to the connected device is generated at the terminal ID1 when the device is connected to the mobile device 10. For example, if the plug 21 of the cable 15 connected to the personal computer 17 is inserted into the port 20, the voltage Vid (a voltage VDD, in this case) according to a resistance value (infinite) at the terminal ID2 and the current Ib are generated at the terminal ID1. If the plug 23 of the cable 16 connected to the monitor 18 is inserted into the port 20, the voltage Vid according to a terminating resistor (75Ω, for example) on the monitor 18 side as well as a resistor 41 and the current Ib is generated at the terminal ID1. It is assumed in an embodiment of the present invention that the resistance value of the resistor 41 is a value sufficiently greater than the resistance value of the terminating resistor on the monitor 18 side. Thus, if the plug 23 of the cable 16 connected to the monitor 18 is inserted into the port 20, the voltage Vid becomes substantially equal to a voltage determined by the terminating resistor on the monitor 18 side and the current value Ib.

If the plug 21 of the cable 15 not connected to the personal computer 17 is inserted into the port 20, the voltage Vid (voltage VDD, in this case) according to the resistance value (infinite) of the terminal ID2 and the current Ib is generated at the terminal ID1. Similarly, if the plug 23 of the cable 16 not connected to the monitor 18 is inserted into the port 20, the voltage Vid according to the resistor 41 and the current Ib is generated at the terminal ID1.

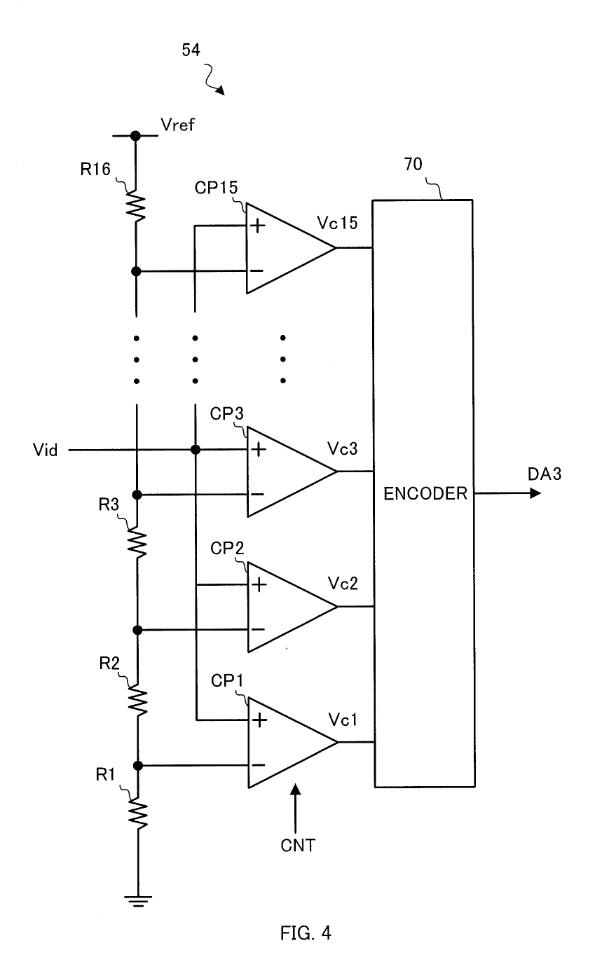

The identification voltage detection circuit 54 (voltage detection unit) is a flash-type AD converter as illustrated in FIG. 4, for example, that converts the voltage Vid at the terminal ID1 into a digital value, and outputs the converted voltage as data DA3. The identification voltage detection circuit 54 includes resistors R1 to R16, comparators CP1 to CP15, and an encoder 70.

Each of the resistors R1 to R16 has a desired resistance value and the resistors are connected in series. The resistor R16A is applied with voltage Vref, and the resistor R1 is grounded. The actual values of the resistors R1 to R16 vary one another, but a description will be given here assuming that they have the same value for convenience.

The comparator CP1 compares magnitude between Vref×1/16 and the voltage Vid, and outputs a comparison signal Vc1. If the voltage Vid is lower than Vref×1/16, for example, the comparison signal Vc1 goes low (“L” level). Whereas, if the voltage Vid is higher than Vref×1/16, the comparison signal Vc1 goes high (“H” level). Each of the comparators CP2 to CP15 compares magnitude between Vref×2/16 to Vref×16/16 (=Vref) and the voltage Vid, similarly to the comparator CP1. Then, the comparators CP2 to CP15 output comparison signals Vc2 to Vc15, respectively.

Moreover, a control signal CNT to stop or start the operations of the comparators CP1 to CP15 is inputted to the comparators CP1 to CP15 from the control circuit 55. When the operations of the comparators CP1 to CP15 are stopped, a current supplied from a bias current circuit (not shown) to the comparators CP1 to CP15 reaches zero, for example. When the operations of the comparators CP1 to CP15 are started, the supply of a current from the bias current circuit (not shown) to the comparators CP1 to CP15 is started. Thus, the comparators CP1 to CP15 output the comparison signals Vc1 to Vc15 according to the voltage Vid only when they are operating.

The encoder 70 encodes the output signals Vc1 to Vc15 of the comparators CP1 to CP15, and outputs the encoded signals as digital data DA3.

The control circuit 55 determines the type of the device connected to the mobile device 10 based on the data DA3 indicating the voltage Vid and the voltage Vbus. For example, if the control circuit 55 determines that a data communication device such as the personal computer 17 or the like is connected to the mobile device 10, the control circuit 55 controls the switch circuit 52 so that the data DA1 and DA2 can be exchanged between the mobile device 10 and the personal computer 17. Specifically, the control circuit 55 switches the switches 60 and 61 so that the terminal A2 and the terminal B2 are connected to each other and the terminal A4 and the terminal B3 are connected to each other, and keeps the switch 62 OFF. Whereas, if the control circuit 55 determines that a display device such as the monitor 18 or the like is connected to the mobile device 10, the control circuit 55 controls the switch circuit 52 so that the audio signals Rin and Lin and the video signal Vs are outputted to the monitor 18. Specifically, the control circuit 55 switches the switches 60 and 61 so that the terminal A3 and the terminal B2 are connected to each other and the terminal A5 and the terminal B3 are connected to each other, and turns ON the switch 62. Further, the control circuit 55 executes various controls based on an instruction (data SDA) inputted from the CPU 31a. Specifically, the control circuit 55 transmits, as the data SDA, the data DA3 indicating the voltage Vid, to the CPU 31a. Furthermore, the control circuit 55 outputs the control signal CNT to stop or start the operations of the comparators CP1 to CP15 based on the instruction from the CPU 31a.

### <<Voltage Vid>>

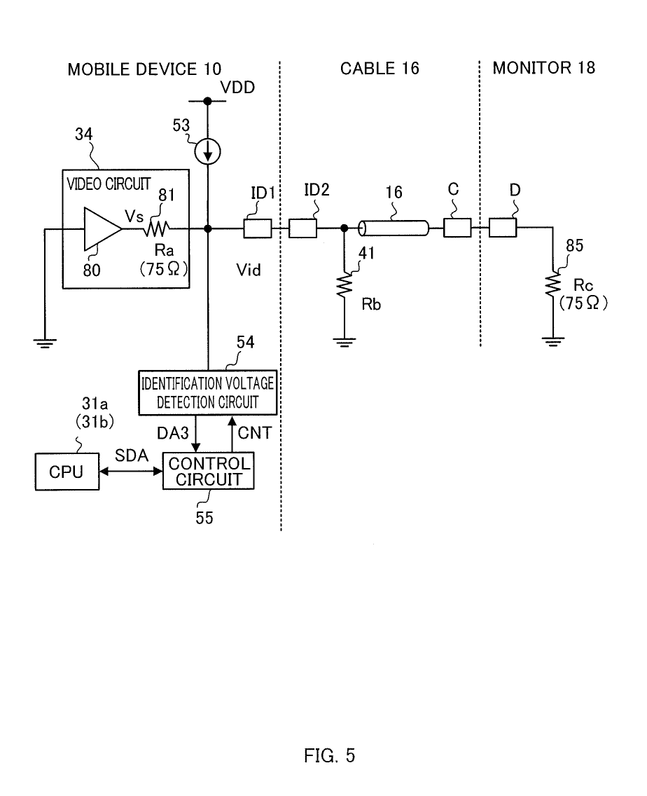

A description will be given here of the voltage Vid when the mobile device 10 and the monitor 18 are connected by the cable 16 by referring to FIG. 5. In FIG. 5, only the major constituents, such as the mobile device 10, are illustrated. Moreover, the video circuit 34 includes a signal output circuit 80 that outputs the video signal Vs and an output resistor (output impedance) 81 of the video circuit 34. It is assumed that the cable 16 and the monitor 18 are connected through terminals C and D, and the terminal D of the monitor 18 is connected to a terminating resistor 85. Each of a resistance value Ra of the output resistor 81 and a resistance value Rc of the terminating resistor 85 is 75Ω, for example, and a resistance value Rb of the resistor 41 is set at a value sufficiently greater than 75Ω (Rb>>75Ω).

Therefore, the voltage of the video signal Vs is divided by the output resistor 81 and the terminating resistor 85, and thus the voltage Vid is given as follows:

Vid≈(1/2)×Vs (1)

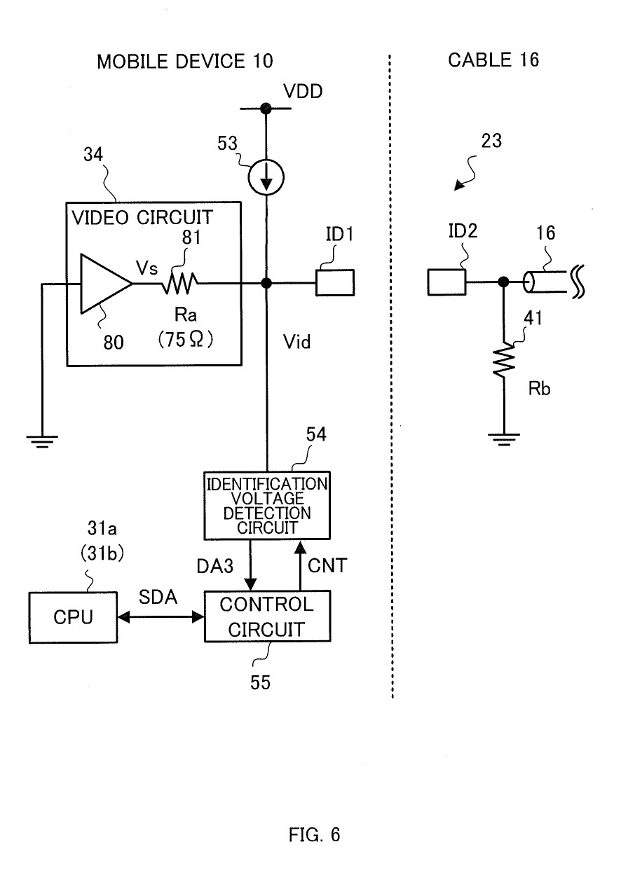

FIG. 6 is a diagram for describing the voltage Vid when the plug 23 on the mobile device 10 side of the cable 16 is disconnected. In this case, the video signal Vs appears at the terminal ID1 as the voltage Vid. That is, the voltage Vid is given as follows:

Vid=Vs (2)

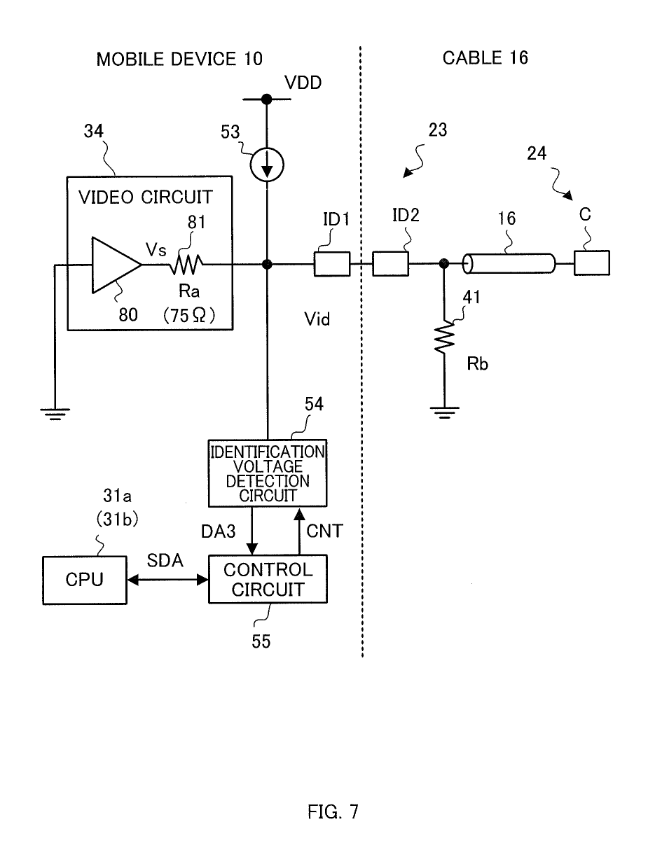

FIG. 7 is a diagram for describing the voltage Vid in the case where the connection of the cable 16 on the monitor 18 side is disconnected. As described above, the resistance value Rb of the resistor 41 is sufficiently greater than the resistance value Ra (75Ω) of the output resistor 81 (Rb>>Ra). Therefore, in this case, the voltage Vid substantially equal to the video signal Vs appears at the terminal ID1. That is, the voltage Vid is given as follows:

Vid≈Vs (3)

As such, if the cable 16 is disconnected between the mobile device 10 and the monitor 18, the voltage Vid substantially doubles in amplitude.

### <<Video Signal Vs>>

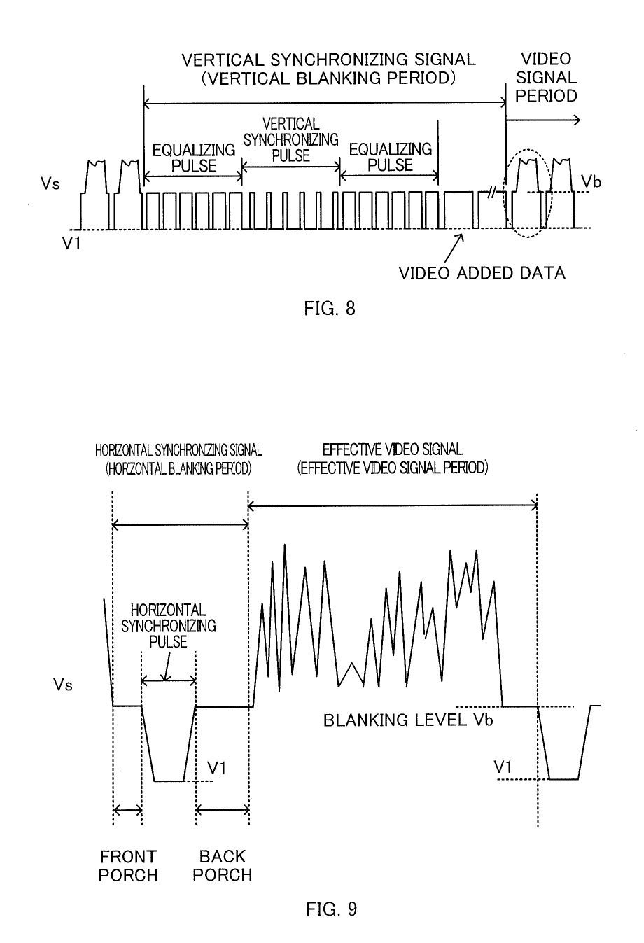

FIG. 8 is a schematic diagram illustrating a vertical synchronizing signal in the video signal Vs. The video signal Vs is assumed to be an NTSC (National Television Standards Committee) type signal, for example, but may be a signal of another type. The vertical synchronizing signal outputted during a vertical blanking period includes video addition data such as an equalizing pulse, a vertical synchronizing pulse, an equalizing pulse, a teletext signal and the like. The minimum level of the vertical synchronizing signal (“L” level of the vertical synchronizing pulse, for example) is assumed to be a positive voltage V1. It is assumed here that the voltage V1 is a positive value but the voltage may be a negative value.

FIG. 9 is a schematic diagram illustrating a horizontal synchronizing signal and an effective video signal in the video signal Vs. The horizontal synchronizing signal and the effective video signal illustrated in FIG. 9 are a magnification of a portion surrounded by a dotted line in FIG. 8. The horizontal synchronizing signal outputted during a horizontal blanking period includes a front porch, a horizontal synchronizing pulse, and a back porch. Then, following the horizontal synchronizing signal, an effective video signal containing brightness of an image and color information is outputted. A DC level of the effective video signal, that is, a blanking level Vb (reference level) is a reference of the DC level in the video signal Vs. The minimum level of the horizontal synchronizing signal (the minimum level of the horizontal synchronizing pulse) also results in the voltage V1 equal to the minimum level of the vertical synchronizing signal.

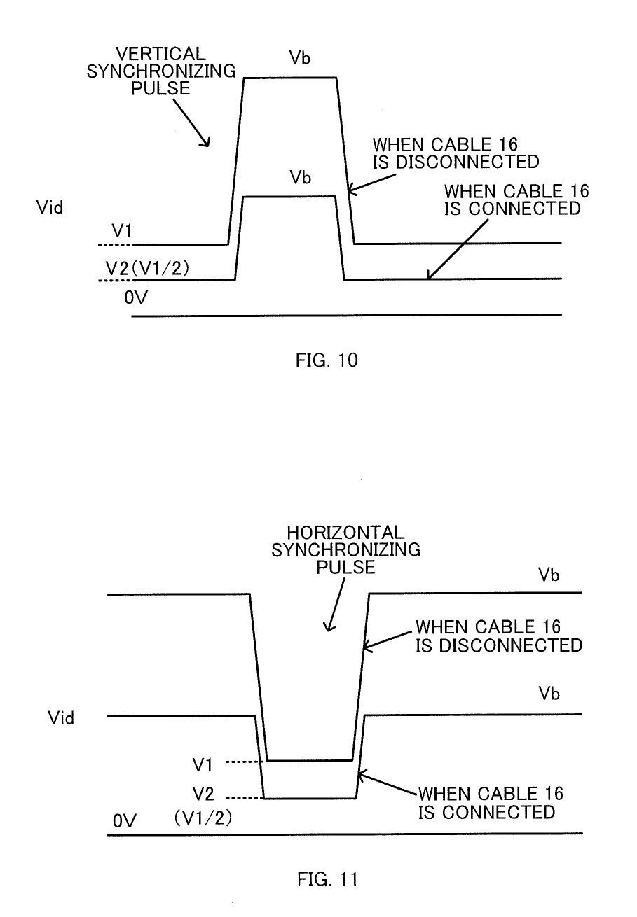

FIG. 10 is a diagram illustrating an example of a waveform of the voltage Vid when the vertical synchronizing pulse of the vertical synchronizing signal is outputted. As illustrated in FIG. 10, if the cable 16 is disconnected between the mobile device 10 and the monitor 18, the minimum level of the voltage Vid is the voltage V1. Whereas, if the cable 16 between the mobile device 10 and the monitor 18 is connected, the minimum level of the voltage Vid is a voltage V2 (=V1/2). In FIG. 10, the vertical synchronizing pulse is described as an example, but the voltage Vid when an equalizing pulse or the like is inputted also changes similarly, for example.

FIG. 11 is a diagram illustrating an example of a waveform of the voltage Vid when the horizontal synchronizing pulse of the horizontal synchronizing signal is outputted. As illustrated in FIG. 11, if the cable 16 is disconnected between the mobile device 10 and the monitor 18, the minimum level of the voltage Vid is the voltage V1. Whereas, if the cable 16 is connected between the mobile device 10 and the monitor 18, the minimum level of the voltage Vid is the voltage V2 (=V1/2).

As such, the minimum level of the voltage Vid detected at the terminal ID1 changes depending on whether the cable 16 is connected or disconnected between the mobile device 10 and the monitor 18. The minimum level of the voltage Vid when the cable 16 is connected between the mobile device 10 and the monitor 18 (hereinafter referred to as when the cable 16 is connected) is the voltage V2. On the other hand, the minimum level of the voltage Vid when the cable 16 is disconnected between the mobile device 10 and the monitor 18 (hereinafter referred to as when the cable 16 is disconnected) is the voltage V1 (>V2).

==Details of CPU 31a==

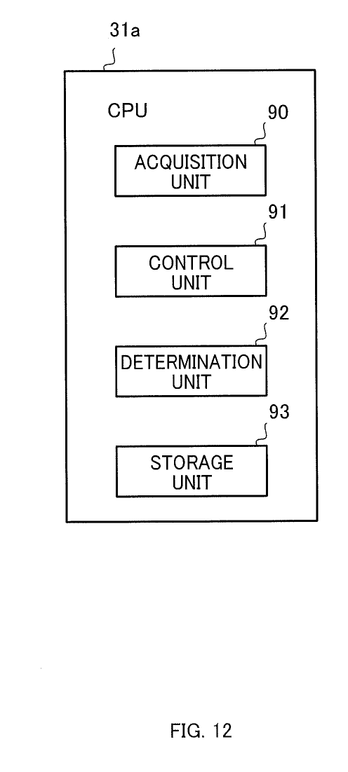

The CPU 31a determines whether the cable 16 is connected or disconnected between the mobile device 10 and the monitor 18 based on the data DA3 indicating the voltage Vid. The CPU 31a realizes various functions by executing the predetermined programs stored in a memory (not shown). Specifically, the CPU 31a realizes the functions of an acquisition unit 90, a control unit 91, a determination unit 92, and a storage unit 93, as illustrated in FIG. 12.

The acquisition unit 90 acquires the data DA3 indicative of the voltage Vid for each predetermined time period T1 (first time period), for example. The data DA3 is outputted as the data SDA from the control circuit 55. Further, it is assumed that the time period T1 is a time period sufficiently shorter than a period of the vertical synchronizing signal, so that the voltage Vid when the vertical synchronizing signal at the minimum level is outputted can be acquired.

The control unit 91 controls each of the blocks of the mobile device 10 based on the voltage Vid acquired by the acquisition unit 90, the determination result of the type of the device connected to the mobile device 10 in the control circuit 55, and further, the determination result of the determination unit 92. The operation of the control unit 91 will be described later in detail.

The determination unit 92 determines whether the cable 16 is connected or disconnected between the mobile device 10 and the monitor 18 based on the data DA3 indicative of the voltage Vid acquired by the acquisition unit 90. The storage unit 93 stores data indicative of the voltage value of the above-described voltage V2 and various types of data, for example.

==Example of Processing Executed by CPU 31a==

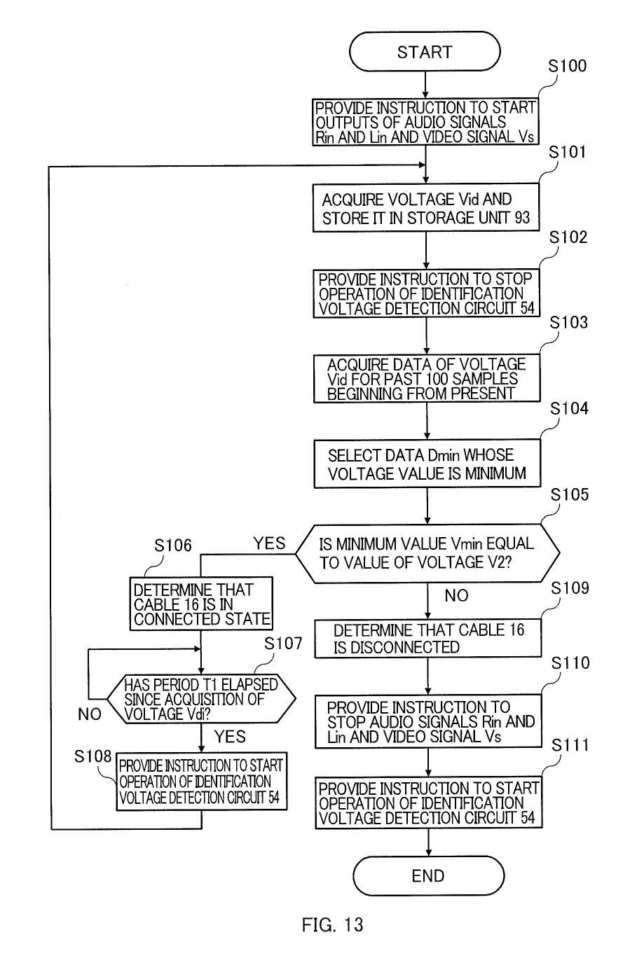

FIG. 13 is an example of processing executed by the CPU 31a when it is determined whether the cable 16 is connected or not between the mobile device 10 and the monitor 18.

It is assumed here that the cable 16 is connected in advance between the mobile device 10 and the monitor 18. Further, it is assumed that the control circuit 55 switches the switches 60 and 61 so that the audio signal Rin is outputted to the terminal B2 and the audio signal Lin is outputted to the terminal B3, and turns on the switch 62 so that the video signal Vs is outputted to the terminal B4.

First, when the control unit 91 receives, from the control circuit 55, the data SDA indicating that the device connected to the mobile device 10 is the monitor 18, the control unit 91 controls the audio circuit 33 and the video circuit 34 so that the outputs of the audio signals Rin and Lin and the video signal Vs are started (S100). Thus, the voltage Vid corresponding to the level of the video signal Vs is generated at the terminal ID1 (terminal B4). Further, the monitor 18 displays an image corresponding to the video signal Vs.

The acquisition unit 90 acquires the data SDA indicative of the voltage Vid from the control circuit 55, and stores the acquired data in the storage unit 93 (S101). When the acquisition unit 90 acquires the data SDA indicative of the voltage Vid, the control unit 91 provides an instruction to stop the operation of the identification voltage detection circuit 54 that converts the voltage Vid into a digital value (S102). Specifically, the control unit 91 transmits, to the control circuit 55, the data SDA to stop the operations of the comparators CP1 to CP15 of the identification voltage detection circuit 54. As a result, the control circuit 55 stops the operations of the comparators CP1 to CP15.

The determination unit 92 acquires last 100 samples of data, for example, which begin from the latest data in the data SDA indicative of the voltage Vid stored in the storage unit 93 (S103). The number of samples (“100”, for example) is set here so that a time period T2 (second time period), during which 100 samples of the data SDA indicative of the voltage Vid are acquired, is longer than the period of the vertical synchronizing signal, for example. Therefore, the data of 100 samples include the data of the voltage Vid obtained when the vertical synchronizing signal of the minimum level is inputted to the terminal ID1, without fail.

The determination unit 92 selects data Dmin whose voltage value is the minimum from the acquired 100 samples of data of the voltage Vid (S104). Then, the determination unit 92 determines whether or not the voltage value indicated by the data Dmin, that is, the minimum value Vmin of the voltage Vid for the 100 samples is equal to the above-described voltage value (predetermined value) of the voltage V2 (S105). The voltage V2 is the minimum value of the voltage Vid when the cable 16 is connected between the mobile device 10 and the monitor 18. Therefore, the determination unit 92 compares the minimum value Vmin of the voltage Vid, measured when the video signal Vs is outputted, with the minimum value of the voltage Vid (voltage value of the voltage V2) obtained when the cable 16 is connected.

Then, if the minimum value Vmin is equal to the voltage value of the voltage V2 (S105: YES), the determination unit 92 determines that the cable 16 is in the connected state between the mobile device 10 and the monitor 18 (S106). If the determination unit 92 determines that the cable 16 is in the connected state, the control unit 91 determines whether the time period T1 has elapsed or not since the acquisition of the voltage Vid performed by the acquisition unit 90 (S107). If the time period T1 has elapsed since the acquisition of the voltage Vid performed by the acquisition unit 90 (S107: YES), the control unit 91 provides an instruction to start the operation of the identification voltage detection circuit 54 (S108). Specifically, the control unit 91 transmits, to the control circuit 55, the data SDA to start the operations of the comparators CP1 to CP15 of the identification voltage detection circuit 54. As a result, the control circuit 55 resumes the operations of the comparators CP1 to CP15. Then, if the operations of the comparators CP1 to CP15 are started, the acquisition unit 90 acquires the voltage Vid and stores it in the storage unit 93 (S101). As such, when the cable 16 is connected between the mobile device 10 and the monitor 18, the voltage Vid is acquired in each predetermined time period T1 and sequentially stored in the storage unit 93.

Whereas, if the minimum value Vmin is not equal to the voltage value of the voltage V2 (S105: NO), the determination unit 92 determines that the cable 16 is disconnected between the mobile device 10 and the monitor 18 (S109). Further, if the determination unit 92 determines that the cable 16 is disconnected, the control unit 91 turns off the switches 60 to 62 and controls the audio circuit 33 and the video circuit 34 so that the outputs of the audio signals Rin and Lin and the video signal Vs are stopped (S110). Then, the control unit 92 provides an instruction to start the operation of the identification voltage detection circuit 54 (S111). As such, the CPU 31a can determine whether the cable 16 is disconnected between the mobile device 10 and the monitor 18 based on the minimum value Vmin of the voltage Vid and the voltage value of the voltage V2. Further, in the processing S111, the operation of the identification voltage detection circuit 54 is resumed. Thus, if a device is newly connected to the mobile device 10, for example, the identification voltage detection circuit 54 can reliably acquire the voltage at the terminal ID1.

### ==Details of Switch IC 36 (Second Embodiment of the Present Invention)==

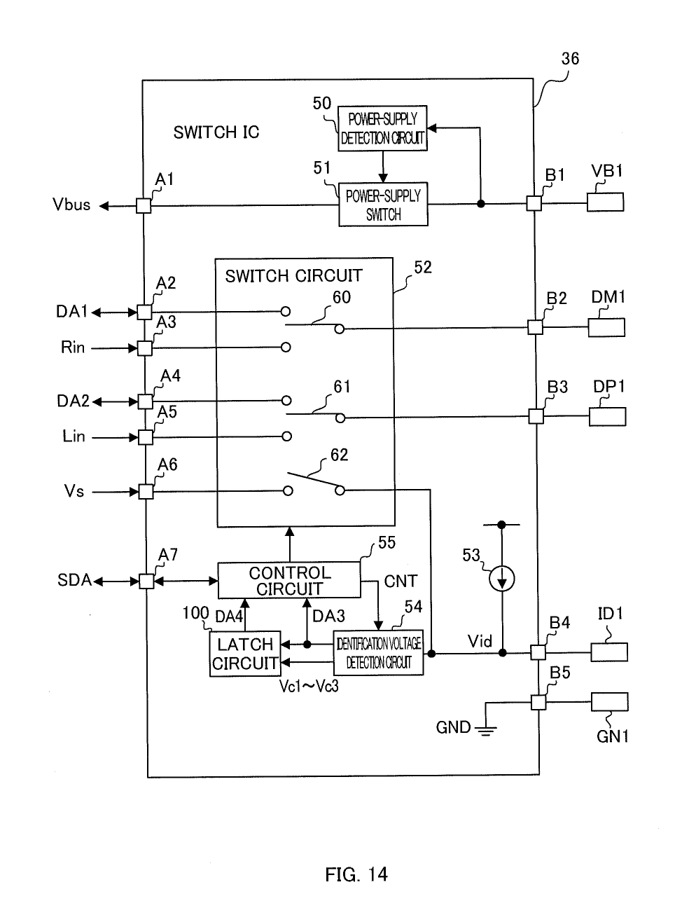

FIG. 14 is a diagram illustrating the details of a switch IC 36 according to a second embodiment of the present invention. The switch IC 36 is used in place of the switch IC 30 in the mobile device 10 illustrated in FIG. 1. In the switch IC 36, a latch circuit 100 is provided in addition to the blocks of the switch IC 30 in FIG. 3. Since the configurations other than the configuration of the latch circuit 100 are similar to those of the circuits in FIG. 3, detailed descriptions thereof will be omitted.

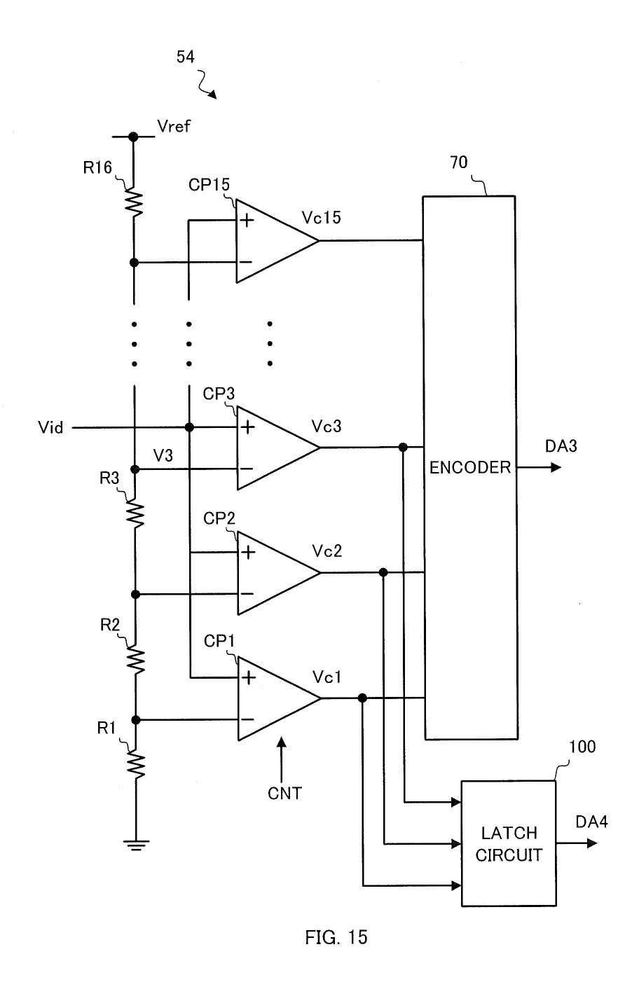

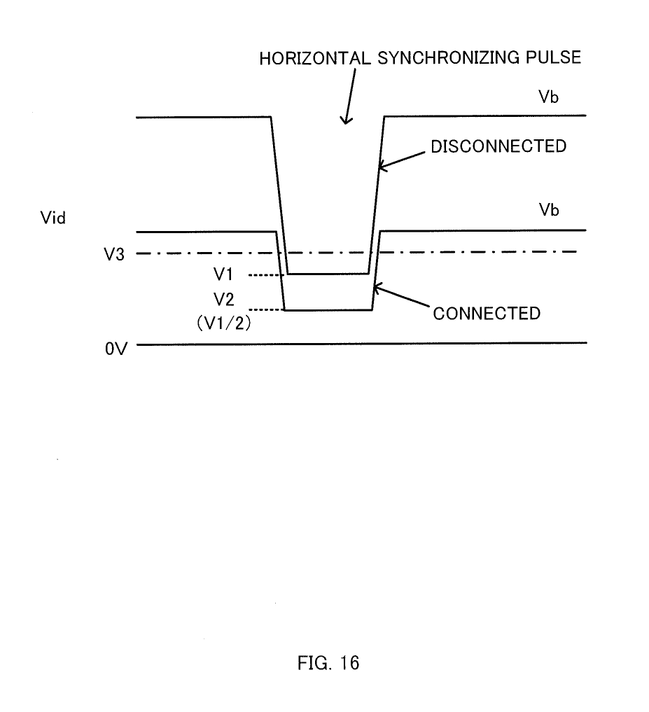

FIG. 15 is a diagram illustrating a connection relationship between the identification voltage detection circuit 54 and the latch circuit 100. The latch circuit 100 is a circuit configured to detect timing ta at which the synchronizing signal (horizontal synchronizing signal and vertical synchronizing signal) of the minimum level is outputted to the terminal ID1, and output, to the control circuit 55, data DA4 indicating the voltage Vid at the timing ta. That is, the latch circuit 100 latches the minimum value of the voltage Vid obtained when the video signal Vs is outputted, and outputs the result to the control circuit 55. Thus, in an embodiment of the present invention, resistance values of the resistors R1 to R16 are selected so that the voltage V3 at an inverting input terminal of the comparator CP3 (comparison unit) that outputs a comparison signal Vc3 reaches a level indicated by a one dot chain line in FIG. 16. The level of the voltage V3 (threshold value) is higher than the minimum level of the horizontal synchronizing signal (level of the voltage V1), which is to be generated at the terminal ID1 when the cable 16 is disconnected between the mobile device 10 and the monitor 18, and is lower than the blanking level of the video signal Vs (reference level), which is to be generated at the terminal ID1 when the cable 16 is connected between the mobile device 10 and the monitor 18. Thus, the comparison signal Vc3 of the comparator CP3 goes low only when the synchronizing signal (horizontal synchronizing signal and the vertical synchronizing signal) of the minimum level is inputted to the terminal ID1.

The latch circuit 100 (acquisition unit) acquires the comparison signals Vc1 to Vc3 when the comparison signal Vc3 goes low. When the comparison signal Vc3 goes low, comparison signals Vc4 to Vc15 go low without fail. Thus, in such a case, the digital value of the voltage Vid is expressed substantially in a 3-bit (comparison signals Vc1 to Vc3) digital value. Thus, when the comparison signal Vc3 goes low, the latch circuit 100 acquires only the comparison signals Vc1 to Vc3, and outputs data DA4 indicative of the voltage Vid.

==Details of CPU 31b==

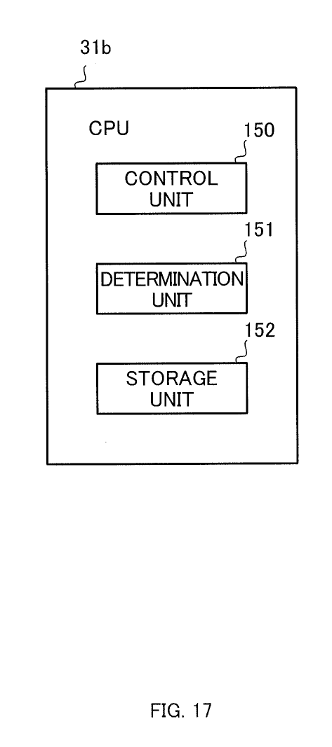

FIG. 17 is a diagram illustrating functional blocks of a CPU 31b used together with the switch IC 36. The CPU 31b determines whether the cable 16 is connected or disconnected between the mobile device 10 and the monitor 18 based on the data DA4 indicative of the voltage Vid.

The CPU 31b realizes various functions by executing the predetermined programs stored in a memory (not shown). Specifically, the CPU 31b realizes the functions of a control unit 150, a determination unit 151, and a storage unit 152. The control unit 150 controls each of the blocks of the mobile device 10, based on the data SDA indicative of the type of the device outputted from the control circuit 55 and the determination result of the determination unit 151. The operation of the control unit 150 will be described later in detail.

The determination unit 151 acquires the data DA4 as the data SDA every time the data DA4 indicative of the voltage Vid is outputted, for example. The determination unit 151 determines whether the cable 16 is connected or disconnected between the mobile device 10 and the monitor 18 based on the acquired voltage value of the voltage Vid. The storage unit 152 stores data indicative of the voltage value of the voltage V2, for example.

==Example of Processing Executed by CPU 31b==

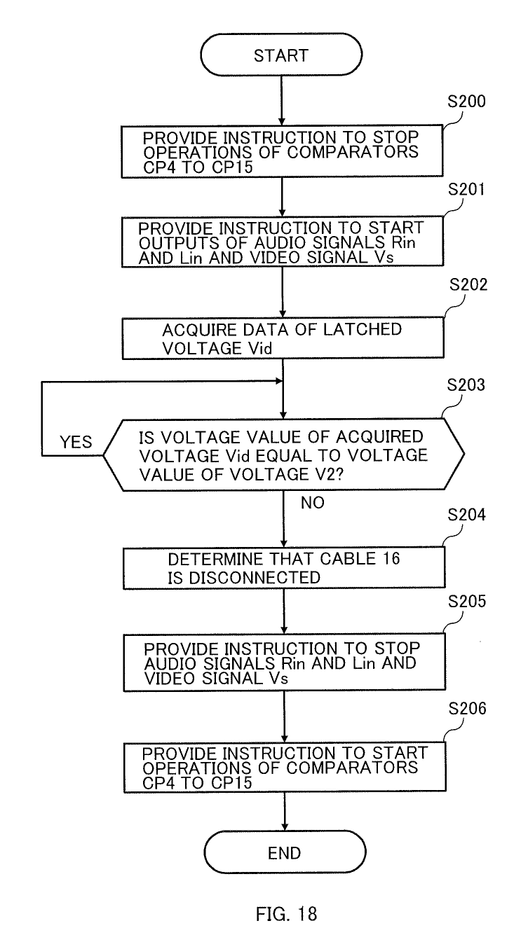

FIG. 18 is an example of processing executed by the CPU 31b when it is determined whether the cable 16 is connected or not between the mobile device 10 and the monitor 18.

It is assumed here that the cable 16 is connected in advance between the mobile device 10 and the monitor 18. Further, it is assumed that the control circuit 55 switches the switches 60 and 61 so that the audio signal Rin is outputted to the terminal B2 and the audio signal Lin is outputted to the terminal B3, and turns on the switch 62 so that the video signal Vs is outputted to the terminal B4.

First, when the control unit 150 receives the data SDA indicating that the monitor 18 is connected to the mobile device 10, the control unit 150 outputs an instruction so as to stop the operations of the 12 comparators CP4 to CP15 out of the comparators CP1 to CP15 in the identification voltage detection circuit 54 (S200). Specifically, the control unit 150 transmits, to the control circuit 55, the data SDA to stop the operations of the comparators CP4 to CP15. As a result, the operations of the 12 comparators CP4 to CP15 are stopped, and such a state is brought about where only three comparators CP1 to CP3 are operated. Then, the control unit 150 controls the audio circuit 33 and the video circuit 34 so that outputs of the audio signals Rin and Lin and the video signal Vs are started (S201). Thus, the voltage Vid corresponding to the level of the video signal Vs is generated at the terminal ID1 (terminal B4), and an image is displayed on the monitor 18. The determination unit 151 acquires the data SDA indicative of the latched voltage Vid (S202). Then, the determination unit 151 acquires data indicative of the voltage V2 stored in the storage unit 152, and determines whether the voltage values of the acquired voltage Vid and the voltage V2 are equal or not to each other (S203).

The voltage value of the voltage Vid acquired by the determination unit 151 is equal to the voltage V2 when the cable 16 is connected between the mobile device 10 and the monitor 18 as illustrated in FIG. 16, for example. Thus, it is determined whether the voltage values of the acquired voltage Vid and the voltage V2 are equal or not to each other, thereby being able to determine whether the cable 16 is disconnected or not between the mobile device 10 and the monitor 18.

The determination unit 151 determines that the cable 16 is disconnected only when the voltage value of the acquired voltage Vid and the voltage value of the voltage V2 are not equal to each other (S203: NO) (S204).

If the determination unit 151 determines that the cable 16 is disconnected, the control unit 150 turns off the switches 60 to 62 and controls the audio circuit 33 and the video circuit 34 so that the outputs of the audio signals Rin and Lin and the video signal Vs are stopped (S205). Further, the control unit 150 provides an instruction to start the operations of the 12 comparators CP4 to CP15 in the identification voltage detection circuit 54 (S206). As such, the CPU 31b can determine whether the cable 16 is disconnected or not between the mobile device 10 and the monitor 18 based on the voltage value of the voltage Vid acquired by the latch circuit 100 and the voltage value of the voltage V2. Further, when the processing S206 is executed, all the comparators CP1 to CP15 in the identification voltage detection circuit 54 are operated. Thus, if a device is newly connected to the mobile device 10, for example, the identification voltage detection circuit 54 can reliably acquire the voltage at the terminal ID1.

Hereinabove, the mobile device 10 to which the present invention is applied has been described. If the cable 16 is connected between the mobile device 10 and the monitor 18, the minimum value of the voltage Vid at the terminal ID1 is equal to the voltage value of the voltage V2. The CPUs 31a and 31b can reliably detect whether the cable 16 is disconnected or not by comparing between the voltage V2 and the minimum value of the voltage Vid.

Further, the acquisition unit 90 in the CPU 31a acquires the voltage Vid in each time period T1. Thus, as compared with a case where a common CPU is caused to continuously acquire the voltage Vid and continue to execute processing, power consumption can be reduced with the CPU 31a in an embodiment of the present invention.

Further, the control unit 91 in the CPU 31a stops the operation of the identification voltage detection circuit 54 when the acquisition unit 90 acquires the voltage Vid, and resumes the operation of the identification voltage detection circuit 54 when the time period T1 has elapsed since the acquisition of the voltage Vid performed by the acquisition unit 90. Thus, the power consumed in the identification voltage detection circuit 54 can be reduced.

Further, the latch circuit 100 reliably acquires the voltage Vid obtained when the synchronizing signal of the minimum level is inputted to the terminal ID1. Then, the CPU 31b can reliably detect whether the cable 16 is disconnected or not by comparing the voltage Vid when the synchronizing signal of the minimum level is inputted to the terminal ID1 with the voltage V2.

Further, the CPUs 31a and 31b detect whether the cable 16 is disconnected or not only based on the voltage Vid of the terminal ID1 (input/output terminal) to which the video signal Vs is outputted out of the five terminals provided in the port 20. Thus, even in a standard different from that for Micro-USB, for example, the effect similar to that in an embodiment of the present invention can be obtained by detecting only the voltage at the terminal to which the video signal Vs is outputted, similarly to the terminal ID1.

In an embodiment of the present invention, the control circuit 55 is configured with hardware but the control circuit 55 may be configured with functional blocks of the CPU 31a, for example.

Further, comparison is made directly with the voltage V2, but the voltage V2 may change with temperature or the like. Thus, the CPU 31a may determine that the cable 16 is disconnected if the minimum value of the voltage Vid exceeds a voltage (V2×1.1, for example) slightly higher than the voltage V2, for example. As such, whether the cable 16 is disconnected or not may be determined based on a predetermined value (V2×1.1, for example) corresponding to the voltage V2 which is to be generated at the terminal ID1 when the cable 16 is connected between the mobile device 10 and the monitor 18.

Further, in an embodiment of the present invention, it is assumed that all of the blanking level Vb, the voltages V1 and V2 are positive values, but the blanking level Vb may be 0 V and the voltages V1 and V2 may be negative values, for example.

Further, if the video circuit 34 outputs a timing signal indicative of timing of the synchronizing signal, for example, the CPU 31a or the like may acquire the voltage Vid obtained when the synchronizing signal of the minimum level is outputted, based on the timing signal. In such a case, the CPU 31a operates similarly to the CPU 3b.

The above embodiments of the present invention are simply for facilitating the understanding of the present invention and are not in any way to be construed as limiting the present invention. The present invention may variously be changed or altered without departing from its spirit and encompass equivalents thereof.

1. A determination circuit comprising:
a terminal configured to be connected to one end of a cable having an other end connected to a display device, so that an image corresponding to an inputted video signal is displayed on the display device;
a voltage detection unit configured to detect a terminal voltage at the terminal; and
a determination unit configured to determine whether the cable is disconnected or not between the terminal and the display device based on a predetermined value corresponding to a minimum level of a synchronizing signal contained in the video signal to be generated at the terminal and a minimum value of the terminal voltage detected when the synchronizing signal is inputted to the terminal, after the cable is connected between the terminal and the display device.

2. The determination circuit according to claim 1, further comprising:
an acquisition unit configured to acquire the terminal voltage detected by the voltage detection unit in every first time period shorter than a period of the synchronizing signal, in order to acquire a value of the terminal voltage at a time when the synchronizing signal of a minimum level is inputted to the terminal, wherein
the determination unit is further configured to determine whether the cable is disconnected or not between the terminal and the display device, based on a minimum value of the terminal voltage value acquired by the acquisition unit in a second time period and the predetermined value, every time the second time period longer than the period has elapsed.

3. The determination circuit according to claim 2, further comprising:
a control unit configured to stop an operation of the voltage detection unit when the acquisition unit acquires the terminal voltage detected by the voltage detection unit, and resume an operation of the voltage detection unit when the first time period has elapsed since acquisition of the terminal voltage by the acquisition unit.

4. The determination circuit according to claim 1, further comprising:
a comparison unit configured to compare a voltage value of the terminal voltage with a threshold value higher than a minimum level of the synchronizing signal to be generated at the terminal in a state where the cable is disconnected between the terminal and the display device and lower than a reference level of the video signal to be generated at the terminal in a state where the cable is connected between the terminal and the display device; and
an acquisition unit configured to acquire the terminal voltage detected by the voltage detection unit when a comparison result indicating that a voltage value of the terminal voltage is lower than the threshold value is outputted from the comparison unit, wherein
the determination unit is further configured to determine whether the cable is disconnected or not between the terminal and the display device based on the terminal voltage acquired by the acquisition unit and the predetermined value.

5. The determination circuit according to claim 1, wherein
the terminal includes an input/output terminal whereto a signal different from the video signal is inputted when the video signal is not outputted from the terminal to the cable.
